(19) United States
(12) Patent Application Publication
(10) Pub. No.: US 2008/0094292 A1
(43) Pub. Date: Apr. 24, 2008

(54) Stylus antenna device

(75) Inventor: Wen-Lin Su, Gueishan Township (TW)

Correspondence Address: TROXELL LAW OFFICE PLLC, SUITE 1404, 5205 LEESBURG PIKE, FALLS CHURCH, VA, 22041, US

(73) Assignee: SPEED TECH CORP., Taoyuan County (TW)

(21) Appl. No.: 11/583,122

(22) Filed: Oct. 19, 2006

(51) Int. Cl. H01Q 1/24

(52) U.S. Cl. 343/702

(57) ABSTRACT

A stylus can be used to operate a mobile communication device and can be used as an external antenna. The stylus can be packed in a containing socket for ease of use. The stylus can also be linked to a signal linking pad to enhance signal receiving ability.

### FIELD OF THE INVENTION

The present invention relates to a stylus; more particularly, relates to obtaining a stylus for operating a mobile communication device and for being used as an antenna with ease of packing and ease of use.

### DESCRIPTION OF THE RELATED ART(S)

A general mobile communication device 3, such as a PDA, a smart phone, etc., is shown in FIG. 5, comprising a touch panel 31 on a surface of the mobile communication device 3; a pressing key 32 on a surface of the mobile communication device 3; an antenna 33 in the mobile communication device 3; a socket 34 at a side of the mobile communication device 3; and a stylus 35 inserted in the socket 34 for operating the mobile communication device 3, where the stylus 35 operates the mobile communication device 3 coordinated with the touch panel 31 and the pressing key 32.

Yet, because a hidden internal antenna 33 in the mobile communication device 3 is used for a beautiful appearance only, the mobile communication devices 3 using this kind of internal antenna 33 may have a bad signal receiving quality owing to a weak signal strength or bad signal distribution in a specific area; or, even more, owing to an obstacle formed by a certain geographical ground or building. Hence, the prior art does not fulfill users' requests on actual use.

### SUMMARY OF THE INVENTION

The main purpose of the present invention is to obtain a stylus to operate a mobile communication device and to be used as an antenna for ease of packing and ease of use coordinated with a signal linking pad and a containing socket.

To achieve the above purpose, the present invention is a stylus antenna device, deposed on a mobile communication device, comprising a signal linking pad; a containing socket; and a stylus movably set on the signal linking pad or the containing socket, where the signal linking pad and the containing socket are set on the mobile communication device; the stylus has a pen body of conductive material; the pen body had a joint at an end movably set on the signal linking pad; and the joint has a pen tip of insulating material at an end. Accordingly, a novel stylus antenna device is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the perspective view showing the preferred embodiment according to the present invention;

FIG. 2 is the explosive view of the preferred embodiment;

FIG. 3 is the view showing the state of taking out the stylus;

FIG. 4 is the view showing the state of use of the antenna; and

FIG. 5 is the perspective view of the prior a rt.

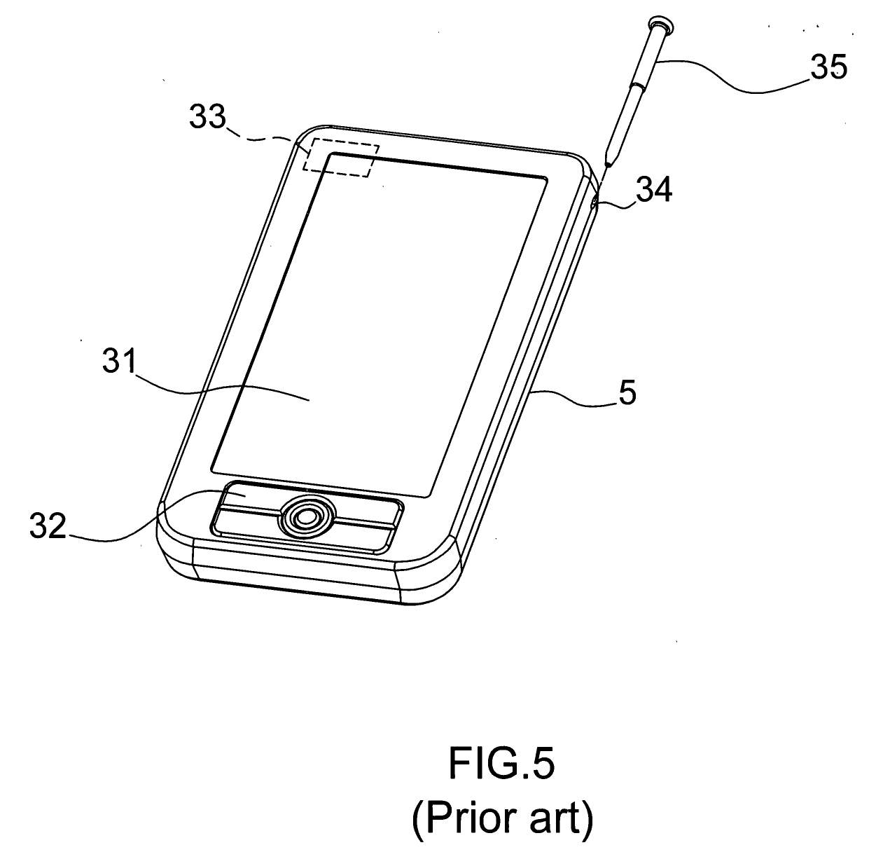

### DESCRIPTION OF THE PREFERRED EMBODIMENT

The following description of the preferred embodiment is provided to understand the features and the structures of the present invention.

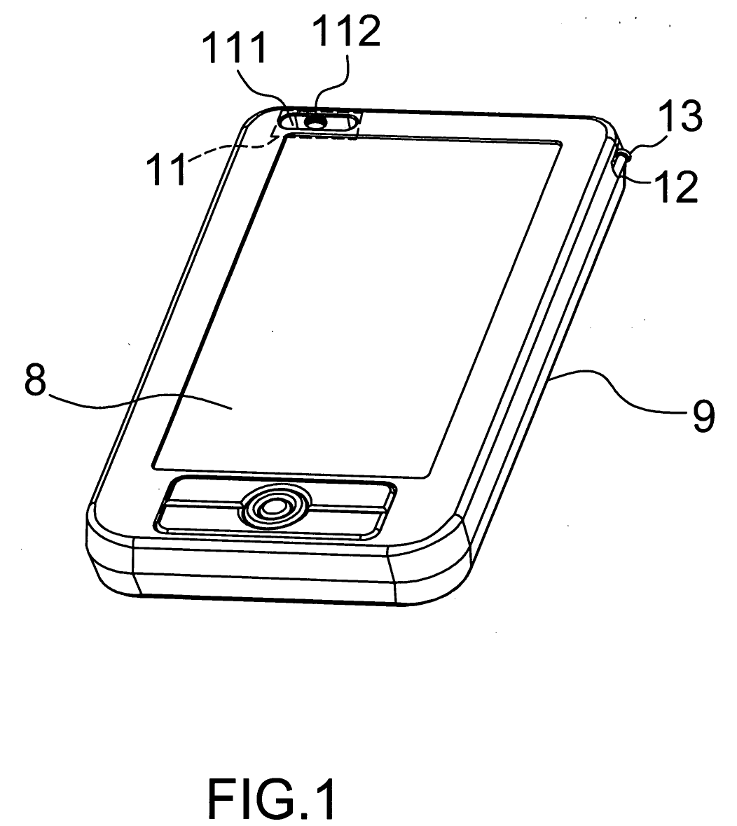

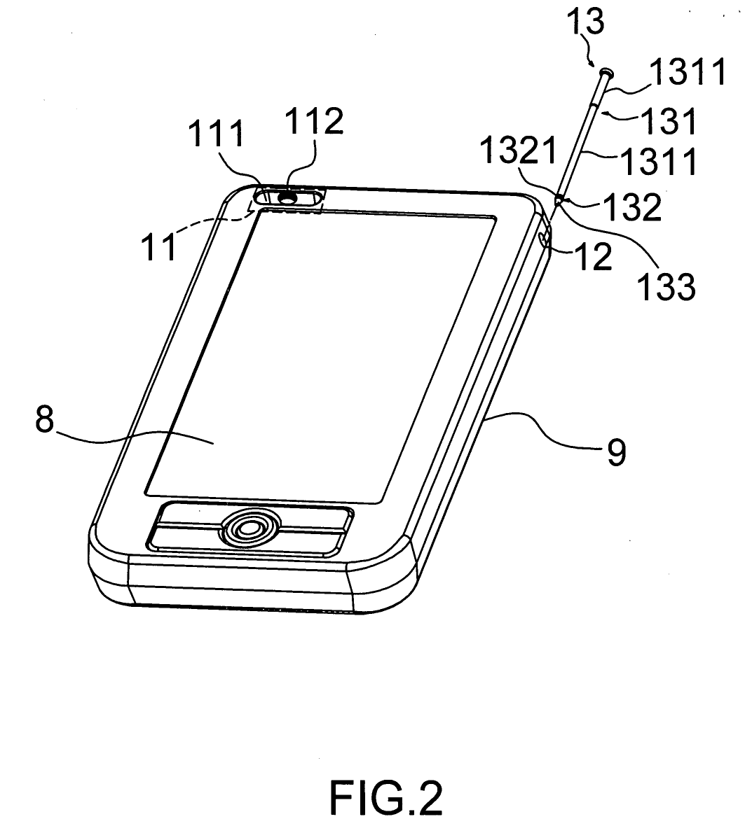

Please refer to FIG. 1 and FIG. 2, which are a perspective view and an explosive view showing a preferred embodiment according to the present invention. As shown in the figure, the present invention is a stylus antenna device 1, deposed on a mobile communication device 9, comprising a signal linking pad 11, a containing socket 12 and a stylus 13, where the stylus 13 is a tool for operating the mobile communication device 9 and is an external antenna; and the stylus 13 is deposed in the signal linking pad 11 or the containing socket 12 for strengthening signals and for ease of use.

The signal linking pad 11 and the containing socket 12 is deposed at proper places on the mobile communication device 9. The mobile communication device 9 is a portable communication device, such as a PDA or a smart phone, etc. The signal linking pad 11 is deposed movably or is fixed at a proper place on the mobile communication device 9, such as on the upper side of the mobile communication device 9 or on a side surface. And the signal linking pad 11 has a concave 111 surrounded by an inner thread 112, or deposed with a convex rib or a gap, or fabricated with any reasonable design on an inner surface.

The stylus 13 is movably set on the signal linking pad 11 or deposed in the containing socket 12 of the mobile communication device 9. The stylus 13 has a pen body 131 made of a conductive material. The pen body 131 is slipped with a plurality of pen sleeves 1311 having various sizes. With the pen sleeves 1311 having various sizes, the pen body 131 is stretchable for various length for various signal bands. Or, the pen body 131 can be a single rod of conductive material to simplify design and to save cost. A joint 132 is located at an end of the pen body 131 for the stylus 13 to be movably set on the signal linking pad 11. On the outer surface of the joint 132, a surrounding outer thread 1321, a gap, or any reasonable design is set according to the design of the signal linking pad 11. And a pen tip 133 of insulating material, such as soft rubber or hard polymer, is set at an end of the joint 132. Or, the pen tip 133 can be integrated with the pen body 132 (not shown in the figure) without affecting signal transmission. Thus, a novel stylus antenna device is obtained with the above structure.

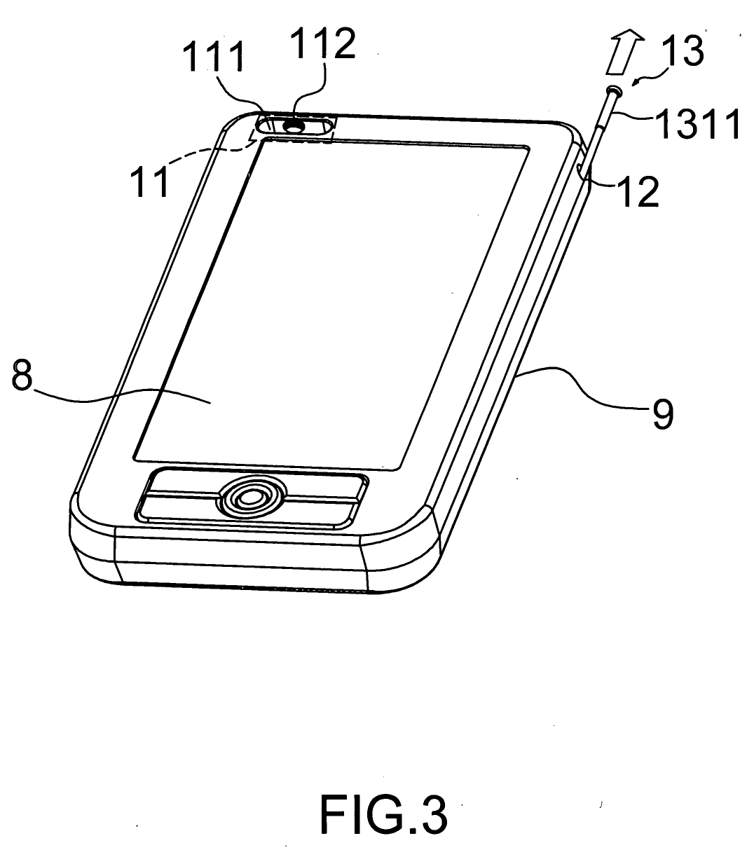

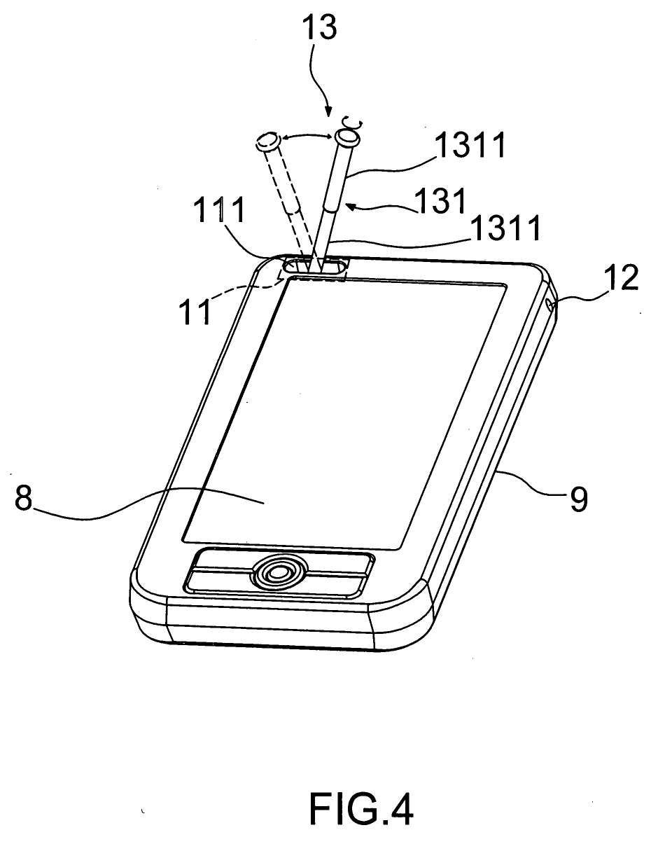

Please refer to FIG. 3 and FIG. 4, which are views showing a state of taking out the stylus and a state of use of the antenna. As shown in the figures, when using the present invention, a stylus 13 is taken out from a containing socket 12 of a mobile communication device 9; and a pen body 131 slipped with a plurality of pen sleeves 1311 are stretched for easy holding for a user. The mobile communication device 9 is operated by using the touch panel 8 with the stylus 13. When the user wants to enhance the signal receiving ability of the mobile communication device 9, the stylus 13 is set on the signal linking pad 11 with the outer thread 1321 of the joint 132 and the inner thread 112 of the concave 111 to be used as an external antenna. And, by using the signal linking pad 11 movably set on the mobile communication device 9, the stylus 13 is freely moved and turned according to the strength of the signal source so that the mobile communication device 9 covers bigger signal receiving band and obtains better signal quality. When the user wants to pack the stylus 13, the stretched pen body 131 with the pen sleeves 1311 is pressed to the original size; and then is inserted into the containing socket 12 of the mobile communication device 9, or is directly plugged to the signal linking pad 11 of the mobile communication device 9. In this way, the stylus 13 is used to operate the mobile communication device 9 or is used as an external antenna with ease of packing and ease of use.

To sum up, the present invention is a stylus antenna device, where a stylus is used to operate a mobile communication device or is used as an external antenna; and, with a signal linking pad and a containing socket, the stylus is easily set and packed for better signal receiving strength and more convenience on using.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A stylus antenna device, said device being deposed with a mobile communication device, comprising:
a signal linking pad;
a containing socket; and
a stylus, said stylus being movably deposed at a place selected from a group consisting of said signal linking pad and said containing socket, said stylus having a pen body made of a conductive material, said pen body having a joint located at an end of said pen body to movably depose said stylus on said signal linking pad, said joint having a pen tip being deposed at an end of said joint.

2. The device according to claim 1, wherein said signal linking pad is fixed at a place of said mobile communication device.

3. The device according to claim 1, wherein said signal linking pad is movably deposed at a place of said mobile communication device.

4. The device according to claim 1, wherein said signal linking pad has a concave; and
wherein an inner thread is surrounded on an inner surface of said concave.

5. The device according to claim 1, wherein said signal linking pad has a concave; and
wherein a convex rib is deposed on an inner surface of said concave.

6. The device according to claim 1,
wherein said signal linking pad has a concave; and
wherein a gap is deposed on an inner surface of said concave.

7. The device according to claim 1, wherein said pen body is slipped with has a plurality of pen sleeves; and
wherein said pen body is movably stretched with said pen sleeves.

8. The device according to claim 1,
wherein said pen body is a single rod.

9. The device according to claim 1,
wherein said joint has an outer thread deposed on an outer surface of said joint.

10. The device according to claim 1, wherein said joint has a gap on an outer surface of said joint.

11. The device according to claim 1,
wherein said joint has a convex on an outer surface of said joint.

12. The device according to claim 1,
wherein said pen tip is made of an insulating material.
